(19) United States
(12) Patent Application Publication
(10) Pub. No.: US 2007/0232822 A1
(43) Pub. Date: Oct. 4, 2007

(54) Azasilanes and method for making and using the same

(75) Inventors: Barry C. Arkles, Dresher, PA (US); Youlin Pan, Langhorne, PA (US); Gerald L. Larson, Newtown, PA (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Gelest, Inc., Morrisville, NJ (US)

(21) Appl. No.: 11/716,134

(22) Filed: Mar. 9, 2007

Related U.S. Application Data
(63) Continuation of application No. 10/421,232, filed on Apr. 23, 2003, now abandoned.
(60) Provisional application No. 60/374,638, filed on Apr. 23, 2002.

(51) Int. Cl. C07F 7/10

(52) U.S. Cl. 556/407

(57) ABSTRACT

A class of volatile cyclic and acyclic azasilanes is provided as well as methods for their preparation which comprise heating aminoalkoxysilanes in the presence of an ammonium salt, sulfuric acid, or phosphonium salt. The cyclic azasilanes may be used for the treatment of inorganic surfaces, particularly nanoparticles, by a ring-opening reaction when non-hydrolytic deposition methods are required.

### CROSS-REFERENCE TO RELATED APPLICATIONS

This application is a continuation of copending application Ser. No. 10/421,232 filed Apr. 23, 2003, entitled Azasilanes and Methods Of Making and Using The Same, and further claims the benefit under 35 U.S.C. §—119(e) of Provisional Application No. 60/374,638, filed Apr. 23, 2002, entitled Azasilanes and Methods Of Making and Using The Same, the entire disclosures of which are incorporated herein by reference.

### BACKGROUND OF THE INVENTION

This invention relates to cyclic and acyclic azasilanes, including volatile azasilanes, which are of particular interest for the surface modification of hydroxyl-containing surfaces, especially inorganic surfaces such as nanoparticles. These azasilanes are also applicable for the functionalization of microelectronic and optoelectronic devices with features less than 10 nanometers, in which monolayer deposition and the formation of high functional density monolayers are critical. Cyclic azasilanes react with the hydroxyl groups of a wide range of substrates at low temperatures by a ring-opening reaction that does not require water as a catalyst.

While cyclic azasilanes have been previously reported in, for example, U.S. Pat. No. 3,146,250 of Speier and in Speier et al. (J Org. Chem., 36(21); 3120, (1971)), little commercial use for the treatment of inorganic surfaces has developed, presumably due to the inability to form the most volatile variations. Specifically, while Speier demonstrated the tendency of azasilacyclopentanes to form, he was not able to form the most volatile members of the series of alkoxy-substituted cyclic azasilanes containing no methyl substituents on the hydrocarbon portion of the ring structure. Later work by Ziche et al. (J Organomet. Chem., 521; 29-31 (1996)) led to the conclusion that the Speier process, which involved chlorinated reactants and byproducts, actually formed a 1,6-diaza-2-silacyclooctane, an eight-membered ring with a silatrane-like structure, rather than the silacyclopentane five-membered ring compound proposed by Speier. Further, U.S. Pat. No. 5,354,880 of Pepe et at. proposes the synthesis of cyclic azasilanes by a method that involves reacting a cyclo-silazine with an isocyanate. By this method, Pepe also did not form 2,2-dimethoxy-I-aza-2-silacyclopentane. Recently, cyclic azasilanes without hydrolyzable groups have been reported in the modification of fillers (i.e., inorganic materials used to modify polymers). However, these were not prepared under anhydrous conditions and did not consider the possibility of post-deposition hydrolytic condensation (M. Vendamuthu et al., J. Undergrad Chem. Res., 1,5, (2002)).

In modification of surfaces with small or “nano-scale” features, it is desirable to effect the functionalization of surface hydroxyl groups in high yield and at low temperatures. In an environment free of water, the reaction of surface hydroxyl groups with alkoxysilanes normally requires either hydrogen bonding of hydroxyl groups with neighboring hydroxyl groups or the addition of hydrogen-bonding additives, such as amines. Alternatively, the alkoxysilane may be prehydrolyzed, but the resulting silanol-containing species tend to self-react and polymerize or are not volatile. For most nano-scale applications, the preferred method of deposition is in the vapor phase since the bulk nature of liquids is a disadvantage in uniformly reaching “nano-scale” features.

Cyclic azasilanes are promising candidates for these applications since they would be expected to undergo a ring-opening reaction with hydroxyl groups driven thermodynamically by the formation of an oxane bond with silicon. Until now, only azasilanes with low volatility have been prepared by synthetic methods which either utilize alkali metals or produce chlorine-containing byproducts, both of which are inconsistent with the materials requirements of microelectronic devices, since they represent undesired contaminants, usually in connection with electrical properties, i.e., conduction.

There thus remains a need in the art for a process for producing a class of cyclic azasilanes, and preferably volatile cyclic azasilanes, in the absence of alkali metals and water and without undesirable chlorine-containing byproducts. Such cyclic azasilanes would have applicability for the surface functionalization of hydroxyl groups in high yield and at low temperature, which would have utility in the microelectronics industry.

### BRIEF SUMMARY OF THE INVENTION

This invention is directed to an azasilacyclopentane having formula (I),

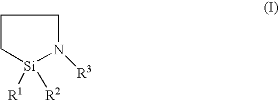

wherein R¹ and R² are independently selected from the group consisting of branched and linear, substituted and unsuhstituted alkyl, alkenyl and alkoxy groups; and wherein R³ is selected from the group consisting of substituted and unsubstituted, saturated and unsaturated, branched and linear aliphatic hydrocarbon groups, substituted and unsubstituted, branched and linear aralkyl groups, substituted and unsubstituted aryl groups, and hydrogen.

This invention also is directed to a diazasilacyclic compound having the formula (III):

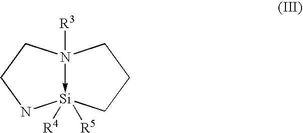

wherein the R³ groups are independently selected (i.e., they may be the same or different) from the group consisting of substituted and unsubstituted, saturated and unsaturated, branched and linear aliphatic hydrocarbon groups; substituted and unsubstituted, branched and linear aralkyl groups; substituted and unsubstituted aryl groups; and hydrogen; and wherein R⁴ and R⁵ are independently selected from the group consisting of substituted and unsubstituted, branched and linear alkyl and alkoxy groups.

This invention also describes an alkoxysilylalkylaminosilane having the formula (IV)

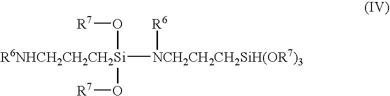

wherein R⁶ is selected from the group consisting of hydrogen; saturated and unsaturated, substituted and unsubstituted aliphatic hydrocarbon groups; and substituted and unsubstituted aryl groups; and wherein R⁷ is selected from the group consisting of substituted and unsubstituted, branched and linear alkyl groups.

This invention also provides an azasilane selected from the group consisting of compounds having formula (I), formula (III), and formula (IV):

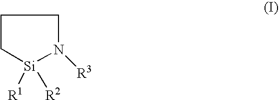

wherein R¹ and R² are independently selected from the group consisting of branched and linear, substituted and unsubstituted alkyl, alkenyl and alkoxy groups; and wherein R³ is selected from the group consisting of substituted and unsubstituted, saturated and unsaturated, branched and linear aliphatic hydrocarbon groups; substituted and unsubstituted, branched and linear aralkyl groups; substituted and unsubstituted aryl groups; and hydrogen;

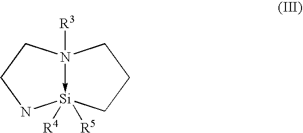

wherein the R³ groups are independently selected from the groups defined above; and wherein R⁴ and R⁵ are independently selected from the group consisting of substituted and unsubstituted, branched and linear alkyl and alkoxy groups; and

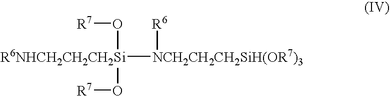

wherein R⁶ is selected from the group consisting of hydrogen; saturated and unsaturated, substituted and unsubstituted aliphatic hydrocarbon groups; and substituted and unsubstituted aryl groups; and wherein R⁷ is selected from the group consisting of substituted and unsubstituted, branched and linear alkyl groups.

A method for producing a volatile cyclic or acyclic azasilane comprising reacting an aminoalkylalkoxysilane with an ammonium salt, sulfuric acid, or a phosphonium salt is also within the invention

Further, the invention includes a method for functionalizing a hydroxyl-containing substrate comprising treating the substrate with a volatile cyclic azasilane or acyclic azasilane in the absence of water, wherein the azasilane is produced in the absence of halogen-containing compounds.

Finally, a method is provided for effecting a high density monolayer on a hydroxyl-containing substrate, comprising treating the substrate with a cyclic azasilane in the absence of water, and subsequently condensing the monolayer by a reaction with water, wherein the cyclic azasilane is produced in the absence of halogen-containing compounds.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawing. For the purpose of illustrating the invention, there is shown in the drawing embodiments which are presently preferred. It should be understood, however, that the invention is not limited to the precise arrangements and instrumentalities shown. In the drawing:

FIG. 1 is an X-ray structure of 2,2-dimethoxy-1,6-diaza-2-silacyclooctane.

### DETAILED DESCRIPTION OF THE INVENTION

This invention relates to a new class of azasilanes, specifically volatile cyclic azasilanes and acyclic azasilanes that may optionally contain alkoxy substituent(s) on the silicon atom, and which may be produced from aminoalkoxysilanes. A volatile compound in this context is one with sufficient vapor pressure, for example, to be transported by a carrier gas such as nitrogen and/or which has the intrinsic ability to diffuse in reaction chambers to the substrate. A typical pressure is about 1 torr at 150° C. As will be described in further detail below, the method of producing an azasilane includes treating the aminoalkoxysilane material with an ammonium salt, sulfuric acid, or phosphonium salt, preferably with an ammonium salt, more preferably with ammonium sulfate, and simultaneously removing an alcohol byproduct when formed. Initially, a mixture containing the cyclic or acyclic azasilane and aminoalkoxysilane starting material is formed. In many cases, the mixture is itself useful, for example, as a direct surface treatment or to modify polymers with hydroxyl groups. Alternatively, a pure cyclic or acyclic azasilane may be distilled in high yield from the mixture.

More specifically, this invention relates to several types of volatile cyclic azasilanes and acyclic azasilanes with different chemical structures and methods for their preparation and use. One type of cyclic volatile azasilane according to the present invention is an azasilanecyclopentane which may be generally represented by the formula (I), in which there are no substituents other than hydrogen on the hydrocarbon portion of the ring which includes those carbons on the ring connected between Si and N.

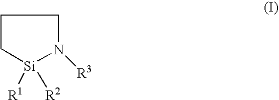

As shown in Formula (I), there can be two non-hydrogen substituents on the silicon atom, represented by R′ and R², which may be the same or different and which may each independently be branched or linear, substituted or unsubstituted, alkyl, alkenyl or alkoxy groups preferably having from 1 to 3 carbon atoms. Heteroatom substituents maybe present as well, so that R¹ and R² may include functional groups such as amines (including tertiary amines), esters, and carboxylate esters. It is preferred that R¹ and R² be alkyl or alkoxy groups. It is further preferred that at least one of R¹ and R² be an alkoxy group, and more preferable that at least one or both are a methoxy or ethoxy group. In a preferred series of compounds, R¹ is an alkoxy group, preferably methoxy or ethoxy, and R² is an alkoxy or alkyl group. Most preferably, both R¹ and R² are methoxy or ethoxy groups.

The R³ substituent on nitrogen may be hydrogen; a saturated or unsaturated, branched or linear, aliphatic hydrocarbon group, a branched or linear aralkyl group, or an aryl group, each with or without heteroatom substituents, having from 1 to 20, preferably 2 to 18 carbon atoms. The term “aliphatic hydrocarbon” may be understood to encompass both saturated groups (alkyl) and unsaturated groups (alkenyl, alkynyl, and allyl groups). Preferably if a heteroatom substituent is used, the heteroatom substituent is an amino group. Exemplary R³ groups include linear and branched alkyl, aminoalkyl, alkenyl, allyl, and alkynyl groups, for example. Preferred R³ groups include alkyl groups, such as methyl, ethyl, n-butyl, t-butyl, n-propyl and isopropyl groups, allyl groups, and aminoalkyl groups, such as 2-aminoethyl. Specific examples of compounds of the general type shown in Formula (I) include 2,2-dimethoxy-N-butyl-1-aza-2-silacyclopentane (as shown in Formula II), 2-methyl-2-methoxy-N-(2-aminoethyl)-1-aza-2-silacyclopentane, 2,2-diethoxy-N-(2-aminoethyl)-1-aza-2-silacyclopentane, 2,2-dimethyl-N-allyl-1-aza-2-silacyclopentane, 2,2-dimethoxy-N-methyl-1aza-2-silacyclopentane, and 2,2-diethoxy-1-aza-2-silacyclopentane.

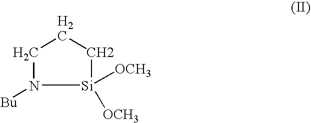

A second type of volatile cyclic azasilane according to the present invention includes diazasilacyclic compounds that may be generally represented by the formula (III).

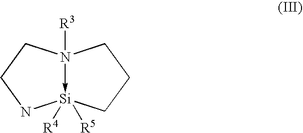

This particular type of compound shows strong coordination of one nitrogen atom with silicon, and may also be regarded as a bicyclic compound with a pentacoordinate silicon. R⁴ and R⁵ may be the same or different and are generally any branched or linear alkyl or alkoxy group preferably having from 1 to 3 carbon atoms. In preferred embodiments, R⁴ and R⁵ are alkoxy groups, such as methoxy or ethoxy. R³ has the meaning noted above, with preferred R³ groups being hydrogen and lower linear alkyl groups (having from 1 to 4 carbon atoms). Each of R⁴, R⁵ and R³ may include various substituent groups, including amines, preferably tertiary amines, esters, carboxylate esters, and aromatic groups. A specific example of a compound of the type shown in Formula (III) is 2,2-dimethoxy-1,6-diaza-2-silacyclooctane. Another exemplary series of compounds represented by Formula (III) contains hydrogen atoms at the R³ positions, R⁴ is an alkyl group (preferably methyl) and R⁵ is an alkoxy or alkyl group (preferably methyl). For example, 2-methyl-2-methoxy- and 2,2-dimethyl-1,6-diaza-2-silacyclooctane would both fall within this exemplary group of compounds.

Finally, a third type of compound which may be prepared according to the present invention is an acyclic azasilane, particularly an alkoxysilylalkylaminosilane which may be generally represented by the Formula (IV):

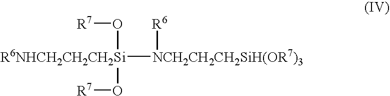

wherein R⁶ may be hydrogen, an aryl group or a saturated or unsaturated aliphatic hydrocarbon group having from 1 to 20 carbon atoms, each of which may optionally contain heteroatom substituents, such as those noted above with respect to Formula (III). Preferably, R⁶ is a substituted or unsubstituted methyl, ethyl, propyl, butyl, or allyl group. R⁷ may be a branched or linear alkyl group, preferably having from 1 to 3 carbon atoms, and is preferably a methyl or an ethyl group, which may also include heteroatom substituents and groups as noted above for R⁶. An exemplary compound according to formula (IV) is N-(N′-butyl-3-aminopropyl(dimethoxysilyl))-N-(N′-butyl)-3-aminopropyl(dimethoxysilyl))-N-(N′-butyl)-3 aminopropyltrimethoxysilane.

The cyclic 1-aza-2-silanes as in Formulas (I) and (III) rapidly react in the vapor or liquid state with a variety of hydroxylic substrates, particularly siliceous and inorganic substrates, and may be applied to a substrate neat or in a solvent, preferably alkanols, such as ethanol, methanol, isopropanol or aqueous ethanol. Substrates may be particulate or flat in configuration. Exemplary particulate substrates are fumed silica, zinc oxide and titanium dioxide. Additional substrates which would be appropriate for the invention include silicon dioxide, silica, glass, qua, alumina, sapphire, titanium and germanium. An exemplary reaction between a substrate and a cyclic azasilane is shown in Figure (V) below. When the substituents on the silicon are not alkoxy groups, no byproducts are formed by such a reaction. Such a functionalization reaction may be attractive for the functionalization of a surface or substrate in high yield, particularly in the microelectronics industry, because no halogen or water is present and there are no halogenated byproducts. When alkyl (typically methyl) groups substitute the silicon, the resulting deposited layer is considered robust, and the film will not form alcohol byproducts on exposure to water.

Conversely, when the silicon is alkoxy-substituted, as shown in Figure (V), subsequent hydrolytic condensation may be utilized to form a more durable monolayer, but alcohol byproducts are formed simultaneously. In many applications it may be desirable to perform such a reaction in the vapor phase to ensure monolayer deposition, and then proceed with a hydrolytic crosslinking of the monolayer following removal of excess (unreacted) silane from the substrate.

Functionalization reactions, such as those in Figure (V), may be performed at room temperature, but are accelerated at elevated temperatures. Preferred temperatures are between ambient and about 150° C. The functionalization reaction is rapid, and may be complete in about 10 minutes. The pressure for the functionalization may be between about 0.001 and 100 atm, and is preferably between atmospheric pressure and 15 atm. Preferably the reaction is performed in the vapor phase, particularly for nanoparticle applications.

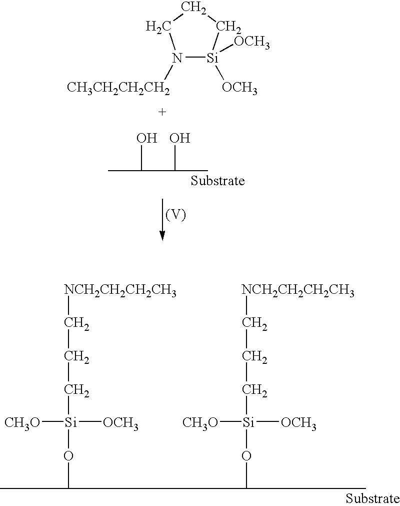

This invention also includes a method for preparing volatile cyclic azasilanes and acyclic azasilanes. The method preferably comprises reacting an aminoalkoxysilane with an ammonium salt. Preferred ammonium salts which may be used in accordance with the present invention may be the salt of ammonium with any known anion, including halide, sulfate, phosphate and trifluoromethanesulfonate. Preferred ammonium salts include ammonium sulfate and ammonium chloride. Although it is preferred if the ammonium salt is neutral, charged species are also within the scope of the invention.

Although ammonium salts are preferred, it is also within the scope of the invention to form the azasilane using sulfuric acid, phosphonium salts or similar materials known in the art or to be discovered which react favorably with aminoalkoxysilanes to form the desired azasilanes. The reaction is preferably performed in the absence of solvent (neat), but may also be performed in a solution of, for example TI-IF, hydrocarbon, or other aprotic solvent. A preferred concentration of the reactants in solvent, if solvent is used, is about 10% by weight. It is preferred that the reaction initially be performed at atmospheric pressure and at a temperature of about room temperature to about 150° C., and preferably about 120 to about 140° C. After the reaction has proceeded for a period of time, preferably about 30-60 minutes, a vacuum is preferably drawn, such as to about 5-15 mm Hg, and any alcohol byproduct formed may be removed from the reaction mixture. The alcohol may be removed, for example, by condensation in a cold trap during distillation or any other separation technique known in the art or to be developed.

A mixture containing azasilane product and starting material is initially formed by the reaction of the aminoalkoxysilane with at least one of, for example, the phosphonium salt, sulfuric acid or preferably ammonium salt. In many cases, the initially formed mixture may be used directly for a surface treatment. Alternatively, the pure cyclic azasilane may be isolated from the reaction mixture, preferably by distillation. Other means for separating the desired product are also within the scope of this invention, such as by trap-to-trap fractionation.

The reaction between aminoalkoxysilane and, for example, ammonium salt to form the volatile cyclic or acyclic azasilanes forms, in addition to the alcohol byproduct, a compound having formula (IV), which may be isolated if desired. Further, reaction of such compounds with alcohol at room temperature produces an exothermic reaction which forms the aminoalkoxysilane starting material.

Suitable aminoalkoxysilane starting materials which may be used according to the method of the present invention preferably include those containing, in addition to the amino substituent, more than one alkoxy substituent on silicon. The alkoxy substituent may be an alkoxy group preferably containing from 1 to 6 carbon atoms, such as methoxy, ethoxy, propoxy, isopropoxy or butoxy. Although it is preferred that all of the alkoxy groups be the same, it is also within the scope of the invention to use aminoalkoxysilanes having different alkoxy substituents. The amino substituent preferably contains at least one N—H group which is preferably located about 3 to about 6 carbon atoms from the silicon, such as aminopropyl. The amino substituent may also contain substituted or unsubstituted, saturated or unsaturated aliphatic hydrocarbon groups or substituted or unsubstituted alkoxy groups, as well as additional substituted or unsubstituted amino groups. For example, the amino substituent may be substituted with an alkyl group, allyl group, or substituted amino group, such as amino ethyl. Exemplary aminosilanes include aminopropyltrimethoxysilane, aminopropyltriethoxysilane, N-methylaminopropyltrimethoxysilane, N-allylaminopropyl trimethoxysilane, N-butylaminopropyltrimethoxysilane, N-2-aminoethylaminopropyltrimethoxysilane, N-2-aminoethylaminopropylmethyldimethoxysilane, N-3 (tert-butyl)aminopropyltrimethoxysilane, N-aminoethyl-3-aminopropylmethyldimethoxysilane, and N-aminoethyl-3-aminopropyldimethylmethoxysilane.

This invention will best be described in conjunction with the following non-limiting examples.

### EXAMPLE 1

This example demonstrates the formation of 2,2-dimethoxy-1,6-diaza-2-silacyclooctane according to the following reaction:

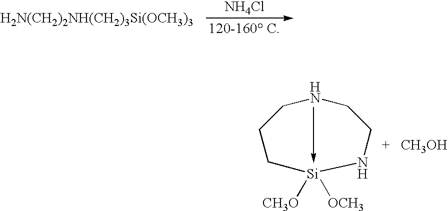

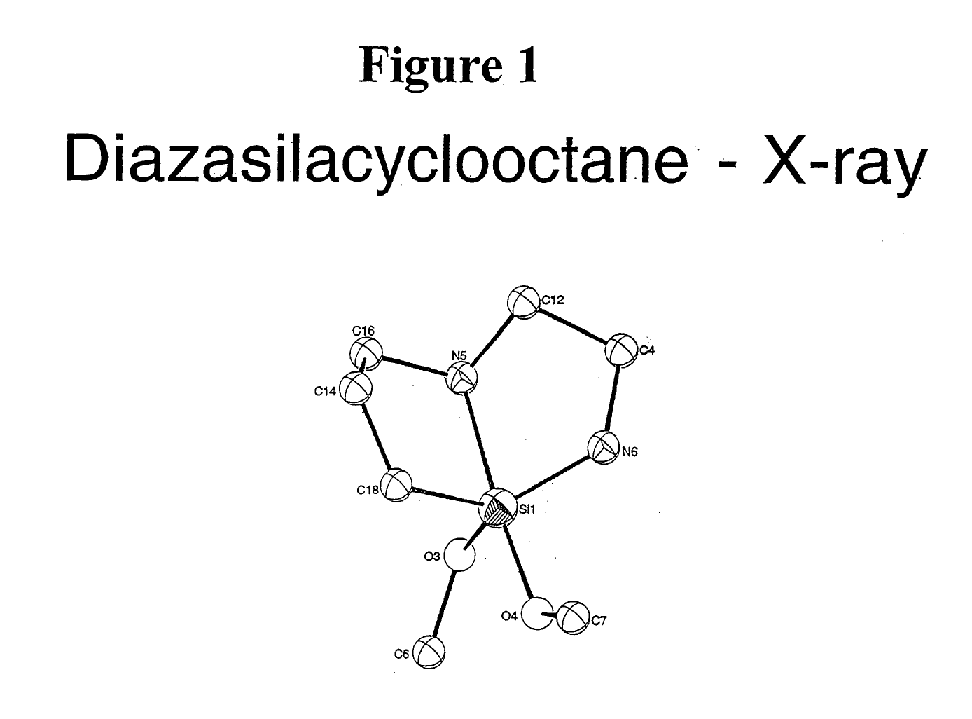

A 1 L 3-necked flask equipped—with a magnetic stirrer, pot thermometer, and short column with distillation head was charged with 679.08 g (3 mol) of N-(2-aminoethyl)-3-aminopropyltrimethoxysilane and 6.80 g (1% by weight) of ammonium chloride. After heating the reaction mixture was maintained at 120-140° C. for 30 minutes, system vacuum was applied and was gradually adjusted to 10 mm Hg. The head temperature rose slowly to 85° C. The product mixture was collected from the distillation apparatus over a temperature range of 85 to 105° C. at 10 mm Hg. At the same time, the methanol byproduct that formed was removed continuously and was condensed separately in a dry-ice trap. 580 g of mixture were generated in 12 hours. White solids formed in the distillate and were separated. The liquid portion was predominantly unreacted starting material. The solids were then washed with pentane and dried under vacuum for 4 hours to yield 248 g of 2,2-dimethoxy-1,6-diaza-2-silacyclooctane (MW 194.32) in 42.5% yield, which had a melting point of 61-62° C. and a boiling point of 71-73° C./2.5 mm Hg. The recrystallized solids were analyzed by NMR, IR and X-ray diffraction, and data consistent with the proposed structure were obtained. The X-ray structure of the product is shown in FIG 1. ¹H NMR(C₆D₆): O.77(m, 2H), 1.36(m, 2H), 1.85(m, 2H), 2.06(m, 2H), 2.58(m, 2H), 3.64(s, 6H).

The experiment was repeated with ammonium sulfate, ammonium trifluoromethanesulfonate and ammonium bromide in place of ammonium chloride. In all cases, identical products and by products in similar yields were obtained.

### EXAMPLE 2

This example demonstrates the formation of 2,2-dimethoxy-N-butyl-1-aza-2-silacyclopentane according to the following reaction:

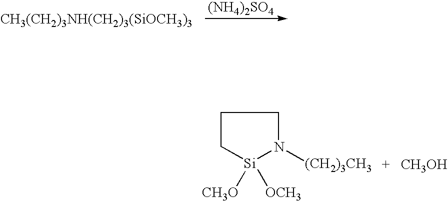

A 1-L 3-necked flask equipped with a magnetic stirrer, pot thermometer and short column with distillation head was charged with 478.80 g (2 mol) of N-(n-butyl)-aminopropyltrimethoxysilane and 4.80g (1% wt) of ammonium sulfate. After heating to 120-140 DC and maintaining for 30 min, system vacuum was applied and was gradually adjusted to 10 mm Hg. The head temperature rose slowly to approximately 85° C. and the distillation receiver was maintained at ambient temperature (20-24° C.). Distillate was collected at a temperature range of 85 to 105° C. at 10 mm Hg. The more volatile methanol byproduct was allowed to bypass the receiver and was collected in a separate dry-ice trap. A total of 420 g of mixture was generated in 12 hours. GC analysis indicated that the mixture contained two principal components. The mixture was then distilled under vacuum to yield 183 g (44.6% yield) of 2,2-dimethoxy-N-butyl-1-aza-2-silacyclopentane (MW 202.36, boiling point=69-71°/3 mm Hg, density=0.941). Higher boiling distillate was identified as starting material. The effective yield was greater than 70%. ¹H NMR(C₆D₆): 0.56(t, 2H), 0.90(t, 3R), 1.28(m, 2H), 1.75(m, 2H), 2.85(t, H), 3.43(s, 6H).

### EXAMPLE 3

This example demonstrates the preparation of N-(N′-butyl-3-aminopropyl(dimethoxysilyl))-N-(N′-butyl)-3-aminopropyltrimethoxysilane. The reaction flask from Example 2 contained a residue which was dissolved in hexane and filtered to remove ammonium sulfate. After removal of the volatile materials, the residue was determined to contain predominately N-(N′-butyl-3-aminopropyl(dimethoxysilyl))-N-(N′-butyl)-3-aminopropyltrimethoxysilane, which has the following structural formula:

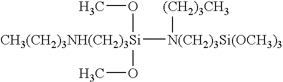

Upon treatment with methanol at room temperature the residue reacted exothermically to form the aminoalkoxysilane starting material from Example 2, n-butylaminopropyltrimethoxysilane.

### EXAMPLE 4

This example demonstrates the formation of 2-methyl-2-methoxyl, 6-diaza-2-silacyclooctane according to the following reaction:

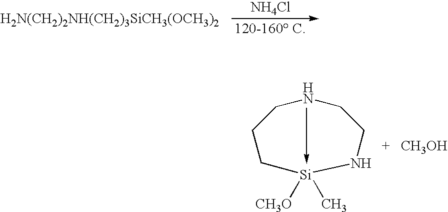

The conditions were similar to those used in Example 1. Specifically, 1 L 3-necked flask equipped with a magnetic stirrer, pot thermometer, and short column with distillation head was charged with 412.72 g (2 mol) of N-(2-aminoethyl)-3-aminopropylmethyldimethoxysilane and 4.13 g (1% wt) of ammonium chloride. After heating to 120-140° C. and maintaining for 30 min, system vacuum was applied and gradually adjusted to 10 mm Hg. The head temperature rose slowly to approximately 85° C. Product mixture was collected at a temperature range of 85 to 105° C. at 10 mm Hg, and 370 g of mixture were generated in 12 hours. The mixture was then subjected to fractionating vacuum distillation. 122 g of 2-methyl-2-methoxy-dimethoxy-1,6-diaza-2-silacyclooctane (MW 174.32), a liquid at room temperature, was obtained; boiling point=70-72° C./3 mm Hg. 1H NMR(C₆D₆): 0.21(s, 3H), O.72(m, 2H), 1.76-255(m, 6H), 2.67(m, 2H), 3.54 (s, 3H).

### EXAMPLE 5

Using the same procedure and reaction conditions described in Example 4, 2,2-dimethyl-1,6-diaza-2-silacyclooctane was prepared using N-(2-aminoethyl)-3-aminopropyldimethylmethoxysilane and ammonium chloride. The product, which had a molecular weight of 156.28 and a boiling point of 54-6° C./2 mm Hg, was collected in low yield.

### EXAMPLE 6

This example demonstrates the preparation of 2,2-diethoxy-1-aza-2-silacyclopentane according to the following reaction:

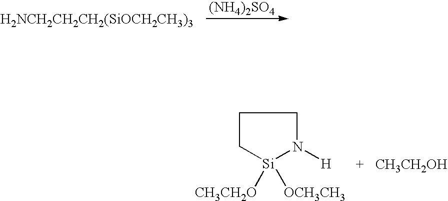

A 1 L 3-necked flask equipped with a magnetic stirrer, pot thermometer, and short column with distill head was charged with 442.74 g (2 mol) of aminopropyltriethoxysilane and 4.80 g (1% wt) of ammonium chloride. After heating to 120-140° C. and maintaining for 30 minutes, system vacuum was applied and was gradually adjusted to 10 mm Hg. The head temperature rose above 75° C. Product mixture was collected at a temperature range of 85 to 105° C. at 10 mm Hg; 380 g of mixture were generated in 12 hours. The mixture was then subjected to vacuum distillation to yield 14.2 g (yield: 8%) of liquid with a boiling point of 69-71°/2.5 mm Hg. The product was determined to be less than 90% pure. It was found that the addition of ethanol gave an exothermic reaction and yielded a single product, aminopropyltriethoxysilane.

### EXAMPLE 7

This example demonstrates the synthesis of 2,2-dimethoxy-N-t-butyl-1-aza-2-silacyclopentane according to the reaction:

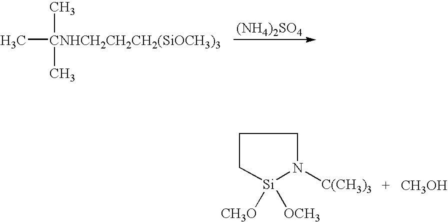

A 1 L 3-neck flask equipped with magnetic stirrer, pot thermometer, short column with distillation head was charged with 239.40 g (2 mol) of N-(t-butyl)-aminopropyltrimethoxysilane and 4.80 g (1% wt) of ammonium sulfate. After heating to 100-120° C., system vacuum was applied and was gradually adjusted to 10 mm Hg. The head temperature rose slowly to 80-100° C., and the distillation receiver was maintained at ambient temperature (20-24° C.). Distillate was collected at a temperature range of 85-105° C. at 10 mm Hg. The more volatile methanol was allowed to bypass the receiver and was collected in a separate dry-ice trap. The distillate was then redistilled under vacuum to yield 205.0 g of 2,2-dimethoxy-N-t-butyl-1-aza-2-silacyclopentane (boiling point 58-60° C./3 mmHg. IH NMR(C₆D₆): 0.55(t, 2H), 1.21(s, 9H), L63(m, 2H), 2.73(t, 2H), 3.45(s, 6H).

### EXAMPLE 8

This example describes the preparation of 2,2-dimethoxy-N-methyl-1-aza-2-silacyclopentane according to the following reaction:

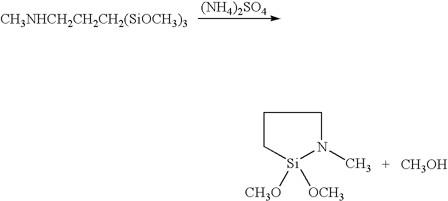

The desired compound was prepared using conditions similar to those described in Example 2. 2,2-dimethoxy-N-methyl-1-aza-2-silacyclopentane, which had a boiling point of 48-49° C./3 mm, was obtained in a lower yield than in Example 2. IH NMR(C₆D₆): 0.51 (t, 2H), 1.72(m, 2H), 251(s, 3H), 2.68(t, 2H), 3.43(s, 6H).

### EXAMPLE 9

This example describes the preparation of 2,2-dimethoxy-N-allyl-1-aza-2-silacyclopentane, which has the following structure:

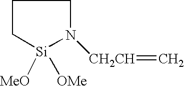

Using conditions similar to those described in Example 2, 2,2-dimethoxy-N-allyl-1-aza-2-silacyclopentane (boiling point 46-48°/3 mm) was prepared in comparable yield.

¹H NMR(C₆D₆): 0.54(t, 2H), 1.70(m, 2H), 2.72(t, 2H), 3.45(s, 6H), 5.06(d, 3H), 5.84(m, 2H).

### EXAMPLE 10

A variety of cyclic azasilane compounds were prepared by the method of Example 2 and the synthesis of each was confirmed by silicon-29 NMR. The Si-29 chemical shifts of exemplary compounds are shown in the following Table:

| Compound | Si-29 chemical shift |
|---|---|
| N-methyl-aza-2,2-dimethoxy-2-silacyclopentane | 21.946 |
| N-butyl-aza-2,2-dimethoxy-2-silacyclopentane | 22.170 |
| N-t-butyl-aza-2,2-dimethoxy-2-silacyclopentane | 23.205 |
| N-allyl-aza-2,2-dimethoxy-2-silacyclopentane | 22.247 |
| N-aminoethyl-aza-2,2-dimethoxy-2- | 64.387 |
| silacyclopentane | |
| N-aminoethyl-aza-2-methyl-2-methoxy-2- | 2.357, 2.665, 5.976 |
| silacyclopentane | |

### COMPARATIVE EXAMPLE

This example describes the preparation of N-aminoethyl-aza-2,2-dimethyl-4-methylsilacyclopentane, which has the following structure:

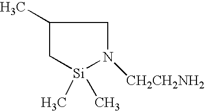

This compound was prepared according to the method of Speier (J Org. Chem., 36(21); 3120, (1971)) via the reaction of 3-chloroisobutyldimethylchlorosilane and ethylenediamine. N-aminoethyl-aza-2,2-dimethyl-4-methylsilacyclopentane (boiling point (54-6°/2 mm) was collected in moderate yield, but with residual chlorinated compounds, i.e., ammonium chloride.

The present invention thus provides methods for synthesizing several classes of volatile cyclic and acyclic azasilanes in the absence of alkali metals and water and without undesirable halogen-containing byproducts. Such cyclic azasilanes are more reactive than conventional (linear) alkoxysilanes and have utility in the microelectronics industry. Specifically, the cyclic azasilanes according to the invention would be appropriate for surface functionalization of hydroxyl groups in high yield and at low temperature without the formation of byproducts, as well as for creating high density monolayers on hydroxyl-containing substrates. These methods thus provide convenient routes to effective surface modification at nanodimensions.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1-22. (canceled)

23. A method for producing volatile cyclic azasilane or acyclic azasilane comprising reacting an aminoalkoxysilane with a compound selected from the group consisting of an ammonium salt, sulfuric acid and a phosphonium salt.

24. The method according to claim 23, further comprising continuously removing an alcohol byproduct from the reaction.

25. The method according to claim 23, wherein the ammonium salt is selected from the group consisting of an ammonium halide, ammonium phosphate, ammonium sulfate, and ammonium trifluromethanesulfonate.

26. The method according to claim 25, wherein the ammonium salt is selected from the group consisting of ammonium sulfate and ammonium chloride.

27. The method according to claim 23, wherein the reaction is performed neat or in tetrahydrofuran or hydrocarbon solvent.

28. The method according to claim 23, wherein the reaction is performed at a temperature of room temperature to about 150° C.

29. The method according to claim 28, wherein the reaction is performed at a temperature about 120° C. to about 140° C.

30. The method according to claim 23, wherein the aminoalkoxysilane contains at least two linear or branched alkoxysilane substituents having 1 to 6 carbon atoms.

31. The method according to claim 23, wherein the aminoalkoxysilane contains an optionally substituted amino substituent located about 3 to 6 carbon atoms from silicon.

32. The method according to claim 31, wherein the amino substituent contains an optionally substituted alkyl, allyl or amino group.

33. The method according to claim 23, wherein the azasilane is selected from the group consisting of compounds having formula (I), formula (III), and formula (IV) 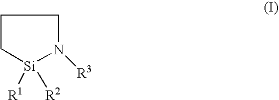
wherein R1 and R2 are independently selected from the group consisting of branched and linear, substituted and unsubstituted alkyl, alkenyl and alkoxy groups; and wherein R³ is independently selected from the group consisting of substituted and unsubstituted, saturated and unsaturated, branched and linear aliphatic hydrocarbon groups; substituted and unsubstituted, branched and linear aralkyl groups; substituted and unsubstituted aryl groups; and hydrogen; 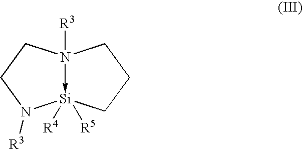
wherein R4 and R5 are independently selected from group consisting of substituted and unsubstituted, branched and linear alkyl and alkoxy groups; 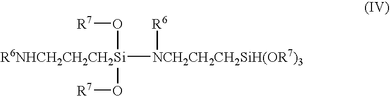
wherein R6 is selected from the group consisting of hydrogen; saturated and unsaturated, substituted and unsubstituted aliphatic hydrocarbon groups; and substituted and unsubstituted aryl groups; and wherein R7 is selected from the group consisting of substituted and unsubstituted, branched and linear alkyl groups.

34. The method according to claim 23, further comprising removing a compound having formula (IV) from the reaction: 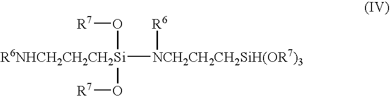
wherein R6 is selected from the group consisting of hydrogen; saturated and unsaturated, substituted and unsubstituted aliphatic hydrocarbon groups; and substituted and unsubstituted aryl groups; and wherein R7 is selected from the group consisting of substituted and unsubstiutted, branched and linear alkyl groups.

35. A method for functionalizing a hydroxyl-containing substrate comprising treating the substrate with a volatile cyclic azasilane in the absence of water, wherein the cyclic azasilane is produced in the absence of halogen-containing compounds.

36. The method according to claim 35, wherein the cyclic azasilane contains no alkoxy substitute on silcon.

37. The method according to claim 36, wherein no byproducts are formed.

38. The method according to claim 35, wherein the substrate is selected from the group consisting of fumed silica, zinc oxide, titanium dioxide, silicon dioxide, glass, quartz, alumina, sapphire, titanium and germanium.

39. The method according to claim 35, wherein the substrate is treated in a vapor or liquid state.

40. The method according to claim 35, wherein the method is performed neat or in an alkanol solvent.

41. A method of effecting a high density monolayer on a hydroxyl-containing substrate comprising treating the substrate with a volatile cyclic azasilane in the absence of water, and subsequently condensing the monolayer by a reaction with water, wherein the cyclic azasilane is produced in the absence of halogen-containing compounds.

42. The method according to claim 41, wherein the substrate is selected from the group consisting of fumed silica, zinc oxide, titanium dioxide, silicon dioxide, glass, quartz, alumina, sapphire, titanium, and geranium.

43. The method according to claim 41, wherein the cyclic azasilane contains at least one alkoxy substituent on silcon.
